(19) United States
(12) Patent Application Publication
(10) Pub. No.: US 2018/0081352 A1
(43) Pub. Date: Mar. 22, 2018

(54) REAL-TIME ANALYSIS OF EVENTS FOR MICROPHONE DELIVERY

(71) Applicant: International Business Machines Corporation, Armonk, NY (US)

(72) Inventors: Tara Astigarraga, Fairport, NY (US); Itzhack Goldberg, Hadera (IL); Jose R. Mosqueda Mejia, Puruandiro (MX); Daniel J. Winarski, Tucson, AZ (US)

(21) Appl. No.: 15/272,583

(22) Filed: Sep. 22, 2016

(51) Int. Cl. G05D 1/00; G10L 15/22; G05D 1/02

(52) U.S. Cl. CPC G05D 1/0016; G10L 15/22; G10L 2015/223; G05D 1/0202; G05D 1/0088

(57) ABSTRACT

A computer-implemented method includes identifying one or more recognition signals from a live video stream of an assembly of people, wherein each recognition signal indicates a request by one or more members of the assembly of people to speak and is identified based, at least in part, on a cognitive system. The computer-implemented method further includes entering each of the one or more members into a recognition queue based on a priority level assigned to each of the one or more members. The computer-implemented method further includes detecting at least a first voice command. The computer-implemented method further includes, responsive to detecting at least the first voice command: Releasing a first member from the recognition queue; Delivering a microphone, via an autonomous vehicle, to the first member; and activating the microphone within a threshold distance of the first member. A corresponding computer program product and computer system are also disclosed.

### BACKGROUND

The present invention relates generally to the field of vehicle control, guidance, operation or indication, and more particularly to an autonomous vehicle having a microphone.

When an assembly of people get together (e.g., meeting, public speaking event, conference, presentation, etc.), it is important that each individual who speaks can be clearly heard and understood. However, when a person desires to speak to a large assembly of people or at a large venue, a microphone may be utilized to amplify a person's voice. For example, in the case of a large assembly of people, a microphone may be subsequently passed from one audience member to another until received by the person who would like to speak. Similarly, in a large venue, an individual, such as a moderator, may provide a person who would like to speak with a microphone by physically walking the microphone to that person. If an assembly takes place in an indoor venue, microphones may be mounted to the walls and/or hung from the ceilings to enhance the level and quality of a person's voice.

### SUMMARY

A computer-implemented method includes identifying one or more recognition signals from a live video stream of an assembly of people, wherein each recognition signal indicates a request by one or more members of the assembly of people to speak and each recognition signal is identified based, at least in part, on a cognitive system. The computer-implemented method further includes entering each of the one or more members into a recognition queue based on a priority level assigned to each of the one or more members. The computer-implemented method further includes detecting at least a first voice command. The computer-implemented method further includes, responsive to detecting at least the first voice command: Releasing a first member from the recognition queue; Delivering a microphone, via an autonomous vehicle, to the first member; and activating the microphone within a threshold distance of the first member. A corresponding computer program product and computer system are also disclosed.

### BRIEF DESCRIPTION OF THE DRAWINGS

FIG. 1 is a functional block diagram of a computing environment, generally designated 100, suitable for operation of a microphone distribution program, in accordance with at least one embodiment of the invention.

FIG. 2 is a flow chart diagram depicting operational steps for a microphone distribution program, in accordance with at least one embodiment of the invention.

FIG. 3 is a block diagram of a computing apparatus 300 suitable for executing a microphone distribution program, in accordance with at least one embodiment of the invention.

### DETAILED DESCRIPTION

Embodiments of the present invention recognize that physically passing around a microphone and/or physically walking a microphone to a speaker is inefficient. For example, in an assembly of people at a large venue, a first speaker may be at one end of the venue, whereas the next speaker may be at the other end of the venue. Embodiments of the present invention recognize that physically passing around a microphone and/or physically walking a microphone to a speaker is time consuming. This becomes problematic when a finite amount of time is allotted for a speaking event (e.g., question and answer sessions are often limited to the final minutes of a meeting, presentation, speech, etc.). Embodiments of the present invention recognize that microphones mounted to a wall or hung from a ceiling often pick up unwanted sound (i.e., “room noise”) and/or reverberation as these microphones try to pick up more distantly located persons. Accordingly, the more distantly located a person is from the microphone, the less clearly that person can be understood. Embodiments of the present invention recognize that a large number of people may all raise their hands to denote a desire to speak within a short time frame (e.g., within seconds of each other). Accordingly, it becomes incredibly difficult for a single person or group of people to accurately identify the order in which hands are raised, the location of the people who raised their hand, and/or the identity of the people who raised their hand. Various embodiments of the present invention may address or improve upon some or all of the aforementioned problems or disadvantages, however it will be understood that addressing any particular problem or disadvantage is not a necessary requirement for the practice of all embodiments of the present invention.

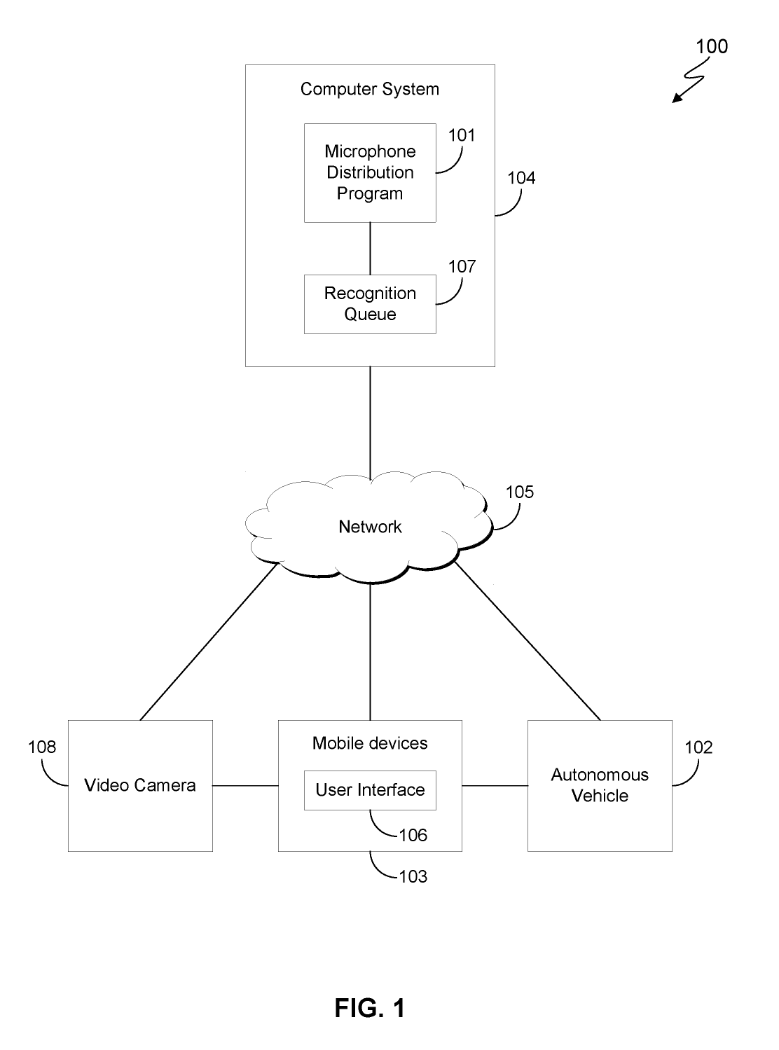

Referring now to various embodiments of the invention in more detail, FIG. 1 is a functional block diagram of a computing environment, generally designated 100, suitable for operation of a microphone distribution program in accordance with at least one embodiment of the invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 includes autonomous vehicle 102 (i.e., a vehicle (e.g., an aerial vehicle) that is capable of sensing its environment and navigating without human input), one or more mobile devices 103, and computer system 104 interconnected over network 105. Network 105 can be, for example, a telecommunications network, a local area network (LAN), a wide area network (WAN), such as the Internet, or a combination of the three, and can include wired, wireless, or fiber optic connections. Network 105 may include one or more wired and/or wireless networks that are capable of receiving and transmitting data, voice, and/or video signals, including multimedia signals that include voice, data, and/or video information. In general, network 105 may be any combination of connections and protocols that will support communications between autonomous vehicle 102, one or more mobile devices 103, computer system 104, and other computing devices (not shown) within computing environment 100. More specifically, network 105 may include wireless peer-to-peer communication protocols including, but not limited to Bluetooth®, Bluetooth® Low Energy (“BLE”), infrared (“IR”), Near-Field Communication (“NFC”), Radio Frequency Identification (“RFID”), etc.

Mobile device 103 may be a laptop computer, tablet computer, smartphone, smartwatch, or any programmable electronic device capable of communicating with various components and devices within computing environment 100, via network 105. In general, a mobile device 103 represents any programmable electronic device or combination of programmable electronic devices capable of executing machine readable program instructions and communicating with other computing devices (not shown) within computing environment 100 via a network, such as network 105. Mobile device 103 includes user interface 106.

User interface 106 provides an interface between a user of a mobile device 103 and computer system 104. In one embodiment, user interface 106 may be a graphical user interface (GUI) or a web user interface (WUI) and can display text, documents, web browser windows, user options, application interfaces, and/or instructions for operation, and include the information (such as graphic, text, and sound) that a program presents to a user and the control sequences the user employs to control the program. In another embodiment, user interface 106 may also be mobile application software that provides an interface between a user of a mobile device 103 and computer system 104. Mobile application software, or an “app,” is a computer program that runs on smartphones, tablet computers, smartwatches and any other mobile devices. User interface 106 enables a user to provide login credentials to access an “app” associated with an event and/or venue on a mobile device 103.

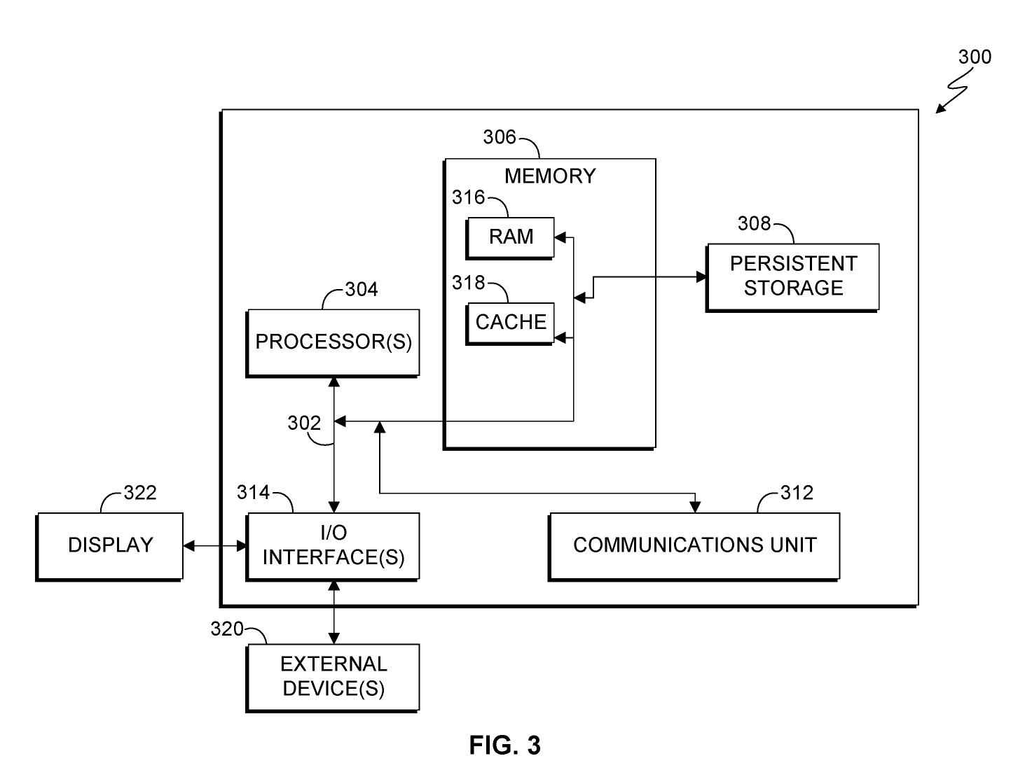

Computer system 104 can be a standalone computing device, a management server, a web server, a mobile computing device, or any other electronic device or computing system capable of receiving, sending, and processing data. In other embodiments, computer system 104 can represent a server computing system utilizing multiple computers as a server system, such as in a cloud computing environment. In an embodiment, computer system 104 represents a computing system utilizing clustered computers and components (e.g., database server computers, application server computers, etc.) that act as a single pool of seamless resources when accessed within computing environment 100. In embodiments, computer system 104 includes microphone distribution program 101 and recognition queue 107, communicatively coupled to computer system 104. Although computer system 104 is depicted in FIG. 1 as being remotely located from autonomous vehicle 102, in some embodiments, computer system 104 is integrated with autonomous vehicle 102. Computer system 104 includes internal and external hardware components, as depicted and described in further detail with respect to FIG. 3.

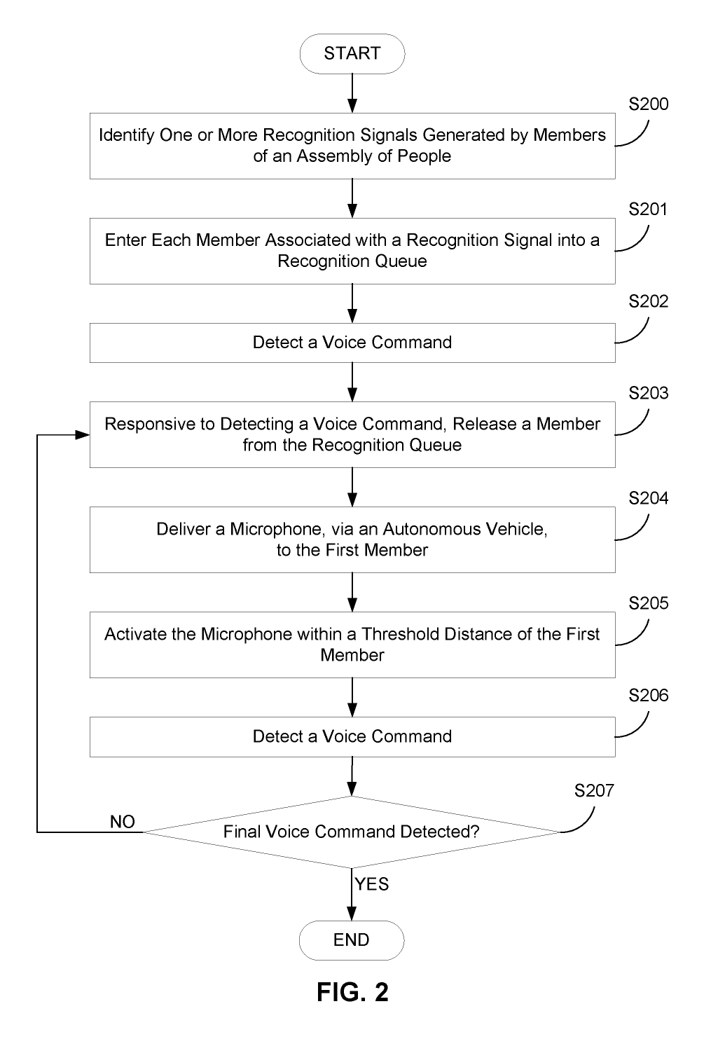

FIG. 2 is a flow chart diagram depicting operational steps for a microphone distribution program 101 in accordance with an embodiment of the present invention. At step S200, microphone distribution program 101 identifies one or more recognition signals from video captured by video camera 108. The one or more recognition signals are generated by an assembly of people. An assembly of people may generally be understood as a meeting or gathering of people (i.e., “members”) based around an event, such as a meeting, conference, speech, presentation, lecture, or wedding. Oftentimes, members of an assembly of people assume the role of viewers, observers, and/or followers during a first part of the event (e.g., presentation) and later assume the role of participants and/or speakers during a second part of the event (e.g., question and answer session after a presentation is given). To demonstrate an interest in participating in the event (e.g., asking a question to a presenter), a member of the assembly of people can employ a verbal and/or visual signal (i.e., “recognition signal”) to gain recognition from a presenter, moderator, etc. Examples of a recognition signal may include, but are not limited to hand raising, arm waiving, standing up, and verbal phrases (e.g., “I have a question” or “I would like to speak”). In some embodiments, microphone distribution program 101 identifies a recognition signal from live video footage captured via video camera 108 mounted to autonomous vehicle 102 (e.g., an aircraft). In some embodiments, microphone distribution program 101 identifies a recognition signal from live video footage captured via video camera 108 mounted to a surface of a venue, such as a wall or ceiling.

In embodiments of the invention, microphone distribution program 101 utilizes a cognitive system. A cognitive system parses various inputs (e.g., photographs, video, streaming video, etc.) to identify one or more recognition signals. More specifically, a cognitive system includes methods for acquiring, processing, analyzing, and understanding digital images. Microphone distribution program 101 receives, via video camera 108, video or streaming video footage of an assembly of people and divides or “breaks” the video footage into individual frames. Generally, a video frame may be understood as being one of many still images (e.g., in some formats, 24 frames may represent one second of film) that compose a complete moving picture. In some embodiments, microphone distribution program 101 identifies one or more recognition signals from a video frame by any generally known object detection methods, such as edge detection. In some embodiments, microphone distribution program 101 performs image recognition of one or more video frames to identify one or more recognition signals. In some embodiments, microphone distribution program 101 identifies a recognition signal from one or more video frames based on any generally known recognition methods, such as appearance-based methods and/or feature-based methods.

In some embodiments of the invention, at step S200, microphone distribution program 101 identifies one or more recognition signals based on user input received via one or more mobile devices 103. For example, John is part of an assembly of people at a stadium. John has a mobile device 103 with an app that is associated with an event (e.g., “Mike's speaking event”) at the stadium. If John would like to speak or ask a question at the start of a question and answer session, John can log into the app by entering his user credentials (e.g., user name and password), via user interface 106. In an embodiment, John utilizes the app to send a request to speak or ask a question to microphone distribution program 101 via text message. In an embodiment, John indicates a request to speak or ask a question by responding to a push-notification (e.g., “Would you like to ask a question?”) received through the app.

At step S201, microphone distribution program 101 enters each member associated with a recognition signal into a recognition queue 107. In some embodiments, the recognition queue 107 is a first-in-first-out (“FIFO”) queue. In some embodiments, members are added to the recognition queue 107 in sequential order based on the time each recognition signal is identified. For example, members are added to the recognition queue 107 based on a timestamp corresponding to the video frame containing the recognition signal. In another example, members are added to the recognition queue 107 based on a timestamp corresponding to a member's text message and/or response to a push-notification. In some embodiments, the recognition queue 107 is a priority queue. With a priority queue, each element (i.e., member) has a priority associated with it. Thus, an element with high priority is served before an element with low priority. If two elements have the same priority, they are served according to their order in the queue (e.g., via timestamp corresponding to an image). In some embodiments, microphone distribution program 101 assigns a higher priority level based on a number of recognition signals generated by each member. For example, microphone distribution program 101 may assign a higher priority level to John if he raises his hand seven times and a lower a priority level to Jane if she one raises her hand twice. In some embodiments, microphone distribution program 101 assigns a higher priority level based on a length of time for each recognition signal. For example, microphone distribution program 101 may assign a higher priority level to John if he keeps his hand raised for two minutes and a lower priority level to Jane if she keeps her hand raised for 10 seconds.

In embodiments of the invention, microphone distribution program 101 utilizes a cognitive system to identify the identity of at least one of the members entered into the recognition queue 107. In some embodiments, microphone distribution program 101 identifies the identity of a member associated with a recognition signal via any generally known facial recognition systems. Here, microphone distribution program 101 compares facial features from a digital image and/or video image of a member taken at the assembly with images stored in a facial database. For example, it may be known that, prior to the start of the assembly, various people of interest will be in attendance (e.g., the president of a company, a political figure, a distinguished professor or scientist, etc.). Accordingly, one or more images of each person of interest can be stored in a database, such that microphone distribution program 101 can compare the facial features of the people of interest in attendance with the stored images. In some embodiments, microphone distribution program 101 identifies the identity of a member via information associated with a member's username. For example, a text message or response to a push-notification under username “John123” can be linked to John. In some embodiments, microphone distribution program 101 assigns a higher priority level to at least one of the members in attendance based on their identity.

In embodiments of the invention, microphone distribution program 101 utilizes a cognitive system to identify a location of each member entered into the recognition queue 107. In some embodiments, microphone distribution program 101 identifies a location of each member based on template matching (i.e., finding parts of an image that match a template image). For example, microphone distribution program 101 compares a template (e.g., a map or layout of a stadium) with an image and/or one or more successive video frames taken during an assembly of people at the stadium. The stadium may be divided by level (e.g., level 1, level 2, and level 3), each level may be divided by zone (e.g., level 1 includes zone 10, zone 11, and zone 12; level 2 includes zone 20, zone 21, and zone 22; level 3 includes zone 30, zone 31, and zone 32), and each zone may further be divided by row and seat number. In the example, John is sitting in level 2, zone 22, row 5. Here, microphone distribution program 101 identifies the location of John by comparing the location of John as depicted in an image or video frame with a layout of the stadium.

In some embodiments, microphone distribution program 101 identifies the location of each member based on natural language processing. For example, microphone distribution program 101 utilizes optical character recognition (“OCR”) to identify John's location based on any typed, handwritten or printed text detected in an image or video frame that indicates John's location (e.g., the words “level 2, zone 22” are located on a wall of the stadium above John's seat). In some embodiments, microphone distribution program 101 identifies a location of each member based on a location of a member's mobile device 103. For example, microphone distribution program 101 determines the location of one or more mobile devices 103 based on any generally known location technologies, including, but not limited to: Global Positioning System (“GPS”), Bluetooth®, Bluetooth® low energy (“BLE”), Near Field Communication (“NFC”), Cell Tower Triangulation, and Wi-Fi Positioning System (“WPS”). In some embodiments, microphone distribution program 101 assigns a higher priority level to at least one of the members in attendance based on their location. For example, people sitting in level 1, zone 10 may be assigned a higher priority level than people sitting in level 2, zone 20.

In alternative embodiments of the invention, microphone distribution program 101 identifies a location of each member entered into the recognition based on information associated with a ticket. For example, microphone distribution program 101 scans a ticket to compare information denoted by the ticket to information corresponding to the purchaser of the ticket (e.g., name, identity, seating location) stored in a database. In embodiments of the invention, microphone distribution program 101 assigns global positioning coordinates to each member entered into the recognition queue based on their identified location.

At step S202, microphone distribution program 101 detects a voice command. In some embodiments, microphone distribution program 101 detects a voice command from a live audio feed captured via a microphone mounted to autonomous vehicle 102 (e.g., an aircraft). In some embodiments, microphone distribution program 101 detects a voice command from a live audio feed captured via a microphone mounted to a surface of a venue, such as a wall or ceiling. In some embodiments, microphone distribution program 101 utilizes a cognitive system to detect voice commands. In some embodiments, microphone distribution program 101 detects a voice command via any generally known speech recognition systems (i.e., automatic speech recognition (“ASR”), computer speech recognition, or speech to text (“STT”)). In some embodiments, microphone distribution program 101 identifies the speaker of a voice command via any generally known voice recognition systems (i.e., speaker identification). Here, a speaker's identity is recognized by matching a speaker's voice to a voice template (i.e., “voice print” or “voice model”). In some embodiments, microphone distribution program 101 includes a set of instructions for dynamically carrying out operations via autonomous vehicle 102 based on the detected voice command. For example, the set of instructions for dynamically carrying out operations via autonomous vehicle 102 may be based on detecting the voice commands “first question,” “next question,” and “last question”. Carrying out the set of instructions may be further based on identifying the speaker of the voice commands. It should be appreciated that microphone distribution program 101 may include any number of instructions for dynamically carrying out operations via autonomous vehicle 102.

At step S203, responsive to detecting a voice command (e.g., “first question”), microphone distribution program 101 releases a first member from the recognition queue 107. In some embodiments, a first member is released based on the first member having the earliest timestamp corresponding to a video frame containing a recognition signal. In some embodiments, a first member is released based on the first member having the highest priority level.

At step S204, microphone distribution program 101 delivers a microphone, via autonomous vehicle 102, to the first member released from the recognition queue 107. In some embodiments, autonomous vehicle 102 locates each member via a GPS. In some embodiments, autonomous vehicle 102 locates each member via Bluetooth® and/or Bluetooth® low energy (“BLE”) beacons emitted from each member's mobile device 103. In some embodiments, autonomous vehicle 102 locates each member based on Cell Tower Triangulation. In some embodiments, autonomous vehicle 102 locates each member based on a WPS. In some embodiments, autonomous vehicle 102 travels at a slower speed or a higher elevation based on a member's location.

At step S205, microphone distribution program 101 activates (i.e., turns on) the microphone within a threshold distance (e.g., 5 feet) of the first member. In embodiments of the invention, microphone distribution program 101 utilizes a cognitive system to determine whether the threshold distance should be modified. In some embodiments, microphone distribution program 101 determines whether the threshold distance should be modified based on an analysis of one or more video frames captured via video camera 108. In some embodiments, microphone distribution program 101 determines whether the threshold distance should be modified based on an analysis of video captured via video camera 108.

In some embodiments, microphone distribution program 101 employs any generally known object detection methods, such as edge detection, to identify objects near each member. In some embodiments, microphone distribution program 101 performs image recognition to identify objects near each member. In some embodiments, microphone distribution program employs any generally known recognition methods, such as appearance-based methods and/or feature-based methods, to identify objects near each member. For example, under normal circumstances, autonomous vehicle will activate a microphone within five feet of John. However, John is currently sitting directly under a ceiling fan. Based on the identification of a ceiling fan near John, autonomous vehicle 102 will modify the distance from which the microphone will be activated (e.g., from 5 feet to 10 feet away from John).

In some embodiments, microphone distribution program 101 employs a speech recognition system to detect if each member is speaking. In some embodiments, microphone distribution program 101 temporarily mutes that microphone based on whether a member is speaking. For example, as John asks a question to a presenter at the stadium, microphone distribution program 101 generates a “voice print” or “voice model” of John's voice. If the presenter then begins to speak, a different “voice print” or “voice model” is generated. Thus, if a different “print” or “model” is identified, but a new voice command has not been detected, microphone distribution program 101 temporarily mutes the microphone while the presenter is speaking. If John later responds to the presenters answer, John's voice print will be identified and microphone distribution program 101 will re-activate the microphone. In some embodiments of the invention, microphone distribution program 101 temporarily mutes the microphone if a member does not speak for a threshold period of time (e.g., 5 seconds).

At step S206, microphone distribution program 101 detects a second voice command. At step S207, microphone distribution program 101 determines whether the voice command is a final voice command (e.g., “that's all the time we have for today,” “thank you for your questions,” “final question,” “last question”). Following the “YES” branch from step S207, in some embodiments, microphone distribution program 101 deactivates the microphone and microphone distribution program 101 terminates. In some embodiments, upon detecting a final voice command, autonomous vehicle 102 returns to its starting position, powers down, and microphone distribution program 101 terminates. Alternatively, following the “NO” branch from step S207, upon detecting a non-final voice command (e.g., “next question” or “moving on to the next person”), the process reverts back to step S203 for a second member entered into the recognition queue 107. Steps S203 through S207 may be repeated for any subsequent number of members entered into the recognition queue 107 until microphone distribution program 101 detects a final voice command.

Some embodiments of the present invention may include one, or more, of the following features, characteristics, and/or advantages: (i) implementing visual analytics to determine an order for which a microphone is delivered to members of an audience via an autonomous vehicle; (ii) delivering a microphone, via an autonomous vehicle, to subsequent members of an audience based on a queue; (iii) implementing facial recognition technologies and/or visual analytics to identify and prioritize the delivery, via an autonomous vehicle, of a microphone to particular members of an audience; (iv) implementing natural processing technologies to determine when a microphone should be delivered, via an autonomous vehicle, to an audience member; (v) reducing the amount of time required to deliver a microphone to an audience member; and (vi) improving the process of speaking and/or asking questions by an assembly of people at a venue.

FIG. 3 is a block diagram depicting components of a computer 300 suitable for executing the microphone distribution program 101. FIG. 3 displays the computer 300, the one or more processor(s) 304 (including one or more computer processors), the communications fabric 302, the memory 306, the RAM 316, the cache 318, the persistent storage 308, the communications unit 312, the I/O interfaces 314, the display 322, and the external devices 320. It should be appreciated that FIG. 3 provides only an illustration of one embodiment and does not imply any limitations with regard to the environments in which different embodiments may be implemented. Many modifications to the depicted environment may be made.

As depicted, the computer 300 operates over a communications fabric 302, which provides communications between the computer processor(s) 304, memory 306, persistent storage 308, communications unit 312, and input/output (I/O) interface(s) 314. The communications fabric 302 may be implemented with any architecture suitable for passing data or control information between the processors 304 (e.g., microprocessors, communications processors, and network processors), the memory 306, the external devices 320, and any other hardware components within a system. For example, the communications fabric 302 may be implemented with one or more buses.

The memory 306 and persistent storage 308 are computer readable storage media. In the depicted embodiment, the memory 306 comprises a random access memory (RAM) and a cache 318. In general, the memory 306 may comprise any suitable volatile or non-volatile one or more computer readable storage media.

Program instructions for the microphone distribution program 101 may be stored in the persistent storage 308, or more generally, any computer readable storage media, for execution by one or more of the respective computer processors 304 via one or more memories of the memory 306. The persistent storage 308 may be a magnetic hard disk drive, a solid state disk drive, a semiconductor storage device, read-only memory (ROM), electronically erasable programmable read-only memory (EEPROM), flash memory, or any other computer readable storage media that is capable of storing program instructions or digital information.

The media used by the persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of the persistent storage 308.

The communications unit 312, in these examples, provides for communications with other data processing systems or devices. In these examples, the communications unit 312 may comprise one or more network interface cards. The communications unit 312 may provide communications through the use of either or both physical and wireless communications links. In the context of some embodiments of the present invention, the source of the source of the various input data may be physically remote to the computer 300 such that the input data may be received and the output similarly transmitted via the communications unit 312.

The I/O interface(s) 314 allow for input and output of data with other devices that may operate in conjunction with the computer 300. For example, the I/O interface 314 may provide a connection to the external devices 320, which may be as a keyboard, keypad, a touch screen, or other suitable input devices. External devices 320 may also include portable computer readable storage media, for example thumb drives, portable optical or magnetic disks, and memory cards. Software and data used to practice embodiments of the present invention may be stored on such portable computer readable storage media and may be loaded onto the persistent storage 308 via the I/O interface(s) 314. The I/O interface(s) 314 may similarly connect to a display 322. The display 322 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying one or more recognition signals from a live video stream of an assembly of people, wherein:
each recognition signal indicates a request, by one or more members of said assembly of people, to speak; and
each recognition signal is identified based, at least in part, on a cognitive system;
entering each of said one or more members into a recognition queue based on a priority level assigned to each of said one or more members;
detecting at least a first voice command based, at least in part, on said cognitive system;
responsive to detecting at least said first voice command:
releasing a first member from said recognition queue;
delivering a microphone, via an autonomous vehicle, to said first member; and
activating said microphone based, at least in part, on said autonomous vehicle being within a threshold distance of said first member.

2. The computer-implemented method of claim 1, further comprising:
detecting at least a second voice command, said second voice command being detected based, at least in part, on said cognitive system;
responsive to detecting at least said second voice command:
deactivating said microphone;
releasing a second member from said recognition queue;
delivering said microphone via said autonomous vehicle to said second member; and
activating said microphone based, at least in part, on said autonomous vehicle being within said threshold distance of said second member.

3. The computer-implemented method of claim 1, further comprising:
identifying an identity of at least one of said one or more members entered into said recognition queue, said identity being identified based, at least in part, on said cognitive system; and
assigning a higher priority level to at least one of said one or more members based on said identity.

4. The computer-implemented method of claim 1, further comprising:
identifying a location of each of said one or more members entered into said recognition queue; and
assigning a higher priority level to at least one of said one or more members based on said location.

5. The computer-implemented method of claim 1, further comprising:
generating a timestamp for each of said one or more recognition signals, said timestamp indicates when each recognition signal is identified.

6. The computer-implemented method of claim 1, wherein said autonomous vehicle includes said microphone.

7. The computer-implemented method of claim 1, wherein said autonomous vehicle is an aircraft.

8. A computer program product, the computer program product comprising one or more computer readable storage media and program instructions stored on said one or more computer readable storage media, said program instructions comprising instructions to:
identify one or more recognition signals from a live video stream of an assembly of people, wherein:
each recognition signal indicates a request by one or more members of said assembly of people to speak; and
each recognition signal is identified based, at least in part, on a cognitive system;
enter each of said one or more members into a recognition queue based on a priority level assigned to each of said one or more members;
detect at least a first voice command based, at least in part, on said cognitive system;
responsive to detecting at least said first voice command:
release a first member from said recognition queue;
deliver a microphone, via an autonomous vehicle, to said first member; and
activate said microphone based, at least in part, on said autonomous vehicle being within a threshold distance of said first member.

9. The computer program product of claim 8, further comprising instructions to:
detect at least a second voice command, said second voice command being detected based, at least in part, on said cognitive system;
responsive to detecting at least said second voice command:
deactivate said microphone;
release a second member from said recognition queue;
deliver said microphone via said autonomous vehicle to said second member; and
activate said microphone based, at least in part, on said autonomous vehicle being within said threshold distance of said second member.

10. The computer program product of claim 8, further comprising instructions to:
identify an identity of at least one of said one or more members entered into said recognition queue, said identity being identified based, at least in part, on said cognitive system; and
assign a higher priority level to at least one of said one or more members based on said identity.

11. The computer program product of claim 8, further comprising instructions to:
identify a location of each of said one or more members entered into said recognition queue; and
assign a higher priority level to at least one of said one or more members based on said location.

12. The computer program product of claim 8, further comprising instructions to:
generate a timestamp for each of said one or more recognition signals, said timestamp indicates when each recognition signal is identified.

13. The computer program product of claim 8, wherein said autonomous vehicle includes said microphone.

14. The computer program product of claim 8, wherein said autonomous vehicle is an aircraft.

15. A computer system, the computer system comprising:
an autonomous vehicle;
a video camera;
a microphone;
one or more computer processors;
one or more computer readable storage media;
computer program instructions;
said computer program instructions being stored on said one or more computer readable storage media;
said computer program instructions comprising instructions comprising instructions to:
identify one or more recognition signals from a live video stream of an assembly of people, wherein:
each recognition signal indicates a request by one or more members of said assembly of people to speak; and
each recognition signal is identified based, at least in part, on a cognitive system;
enter each of said one or more members into a recognition queue based on a priority level assigned to each of said one or more members;
detect at least a first voice command based, at least in part, on said cognitive system;
responsive to detecting at least said first voice command:
release a first member from said recognition queue;
deliver said microphone, via said autonomous vehicle, to said first member; and
activate said microphone based, at least in part, on said autonomous vehicle being within a threshold distance of said first member.

16. The computer system of claim 15, further comprising instructions to:
detect at least a second voice command, said second voice command being detected based, at least in part, on said cognitive system;
responsive to detecting at least said second voice command:
deactivate said microphone;
release a second member from said recognition queue;
deliver said microphone via said autonomous vehicle to said second member; and
activate said microphone based, at least in part, on said autonomous vehicle being within said threshold distance of said second member.

17. The computer system of claim 15, further comprising instructions to:
identify an identity of at least one of said one or more members entered into said recognition queue, said identity being identified based, at least in part, on said cognitive system; and
assign a higher priority level to at least one of said one or more members based on said identity.

18. The computer system of claim 15, further comprising instructions to:
identify a location of each of said one or more members entered into said recognition queue; and
assign a higher priority level to at least one of said one or more members based on said location.

19. The computer system of claim 15, further comprising instructions to:
generate a timestamp for each of said one or more recognition signals, said timestamp indicates when each recognition signal is identified.

20. The computer system of claim 15, wherein said autonomous vehicle is an aircraft.
